(19) United States
(12) Patent Application Publication
(10) Pub. No.: US 2008/0037720 A1
(43) Pub. Date: Feb. 14, 2008

(54) Voice Activated Communication Using Automatically Updated Address Books

(75) Inventors: David L. Thomson, Lisle, IL (US); Michael D. Metcalf, Ladera Ranch, CA (US); Tracy Roberts, Mountain View, CA (US)

Correspondence Address: DAVID L. THOMSON, 4480 BASSWOOD DR., LISLE, IL, 60532, US

(73) Assignee: SpeechPhone, LLC, Rancho Santa Margarita, CA (US)

(21) Appl. No.: 11/460,624

(22) Filed: Jul. 27, 2006

(51) Int. Cl. H04M 1/64

(52) U.S. Cl. 379/88.01

(57) ABSTRACT

A method of communication using voice commands is described where a user's address book is automatically kept up-to-date by gleaning information from contacts listed in the address book and where information in the address book is used for voice dialing and for other communication services.

### FIELD OF THE INVENTION

The present invention relates to telecommunications systems and methods and, more particularly, to a method for setting up communication between two parties using voice commands.

### BACKGROUND OF THE INVENTION

An inconvenient step in placing phone calls is in looking up and dialing the destination number. Electronic address books help clients organize contact information, including notably the name and number of associates. These address books reside on some form of computer and expedite storing and changing records, but keeping an address book up-to-date is a challenge. As people move, change jobs, or change service providers, old phone numbers and other information are replaced with new information.

Retrieving and using information from address books can be inconvenient. To place a phone call, for example, the client must look up the information, read the field containing the phone number, and dial the number. This can be tedious, and, if the client is driving, even dangerous.

One innovation that speeds placing phone calls is voice dialing, using speech recognition to recognize a spoken name, then looking up the number in an address book. While speech recognition relieves the client from pressing buttons, complexities of keeping the address book current and of conveniently linking the address book to the voice dialer remain.

A further shortcoming of the standard electronic address book is that the owner (referred to here as a client) must somehow obtain contact and other information—name, number, email address, etc.—from each associate. Sometimes only partial information is available.

An additional difficulty faced by address book strategies is that of security and privacy. Associates may wish to be reachable, but may be reluctant to share private information. An associate may use call blocking, but call blocking is easily circumvented by calling from a different phone. An associate may change his/her number or request an unlisted number, but then the associate's friends may also have difficulty reaching the associate.

What is needed is a method for conveniently keeping address books up-to-date and easy to use for voice dialing and related applications while protecting the privacy of associates listed in the address book.

### SUMMARY OF THE INVENTION

In accordance with one aspect of the invention, the aforementioned problem is solved and a technological advance achieved by linking elements in an address book with profiles maintained by associates listed in the address book and by allowing the address book owner to access and/or use address book entries by voice commands.

In at least one embodiment of the invention where privacy is important, associates have the ability to define public fields in their own profile that are shared with an address book owner while keeping other information, such as home telephone numbers and email addresses, protected. Clients can reach associates by entering information corresponding to a shared field and this information is securely mapped to a protected field so that the client can reach the associate.

In one example of this first embodiment, a client speaks the name or pseudonym of an associate. A voice dialer finds the pseudonym in the client's address book and finds a record for said associate. Using this record, the voice dialer retrieves the telephone number from the associate's profile and dials the number. (Alternatively, the associate's profile information is copied into said client's address book and retrieved from the address book.) Note that in this first example, the client may or may not be able to read the associate's telephone number.

In a second embodiment, where privacy is less important, the associate's contact information (telephone numbers, email addresses, and other fields that can be used to communicate directly with the associate) are shared with the client. In this second embodiment, the client has one piece of information and this information is used to index the associate's profile and retrieve other information from the associate. This other information allows the client to communicate with (including call, message, or contact) the associate.

In one example of this second embodiment, a client's address book contains an email address for an associate. An automated system such as a communication assistant finds the profile of an associate with the same email address as that listed in the address book and retrieves other information (optionally limited to information that the associate allows to be shared) from the profile and uses this other information to update the client's address book. This update step may be a link, a copy, a shared resource, or other similar process as described in the following paragraph. The other information mentioned above may include, for example, a telephone number, which the client can then use to call the associate by speaking the associate's name.

In computer science terminology, the word “link” is sometimes used to refer to a software pointer. In the current disclosure, we employ a broader definition and use the word “link,” “linked,” or “linking” to refer to the process of updating one or more elements in an address book record using information from a profile. Depending on the software and hardware architecture at hand, it may be convenient to “link” in the classical sense (i.e. provide a software pointer); to copy, where elements of a profile are copied into address book record fields; to share common registers, for example, where a profile element and an address book record element share memory space so that when one is updated, the other is updated automatically; or by other means to make profile elements available in an address book. If an element in a profile is linked to a field in an address book, then the element may be retrieved, according to our terminology, from the address book, regardless of whether the information is literally in the address book or whether it is merely connected to the address book by a pointer or some other link. Also, in order to efficiently teach principles set forth in the current invention, we generally refer to an address book and a profile as separate entities; however, an address book record and a profile need not be separate. For brevity and clarity, we generally use phraseology such as “a profile element is linked to an element in an address book record,” but it is to be understood that the elements may be linked with a pointer, may be copied, or may share memory space without departing from the spirit of the current invention.

It is useful to point out that, when a first element is linked to a second element, the second element is erased and replaced with the first element; whereas, if the elements are not linked, the second element retains its previous value. This linking property is useful for address books, as illustrated by an example: Suppose a client populates an address book record with the name, email address, and phone number of an associate (let's call her Tracy Roberts). If the client then connects to a communication assistant and says, “Call Tracy Roberts,” the communication assistant calls Tracy using the phone number currently in the record. If Tracy changes her phone number in her profile and the new phone number is linked to the record for Tracy Roberts in said client's address book, then the command, “Call Tracy Roberts” will now direct a call to the new number.

A conditional linking strategy disclosed in the current invention accounts for two cases: (1) If the profile is not linked to the address book, the phone call is placed to the number currently residing in said address book, advantageously placed there by the client and (2) if a new number in a profile is linked to the address book, the phone call (or other action) uses the new number. It is to be understood that, when we speak of linking, that if no link is created, there still may be sufficient information in an address book record to execute a useful action.

For convenience, a few terms are defined as follows:

Client—An address book owner or the person who wishes to contact an associate or to perform an action relating to an address book.

Address book—a contact list that contains records of associates. The address book may take the form of a database, a text file, a software array, or any other form that allows reading and writing information. See FIG. 6 and related text for details and an example.

Associate—A person or entity listed in an address book. Although a client may list himself/herself in an address book, it is understood that, for purposes of the current invention, when we use the term “associate,” that we are not referring to the client.

Element—A piece of information related to an associate. See FIG. 6 and related text for details.

Field—A storage location in an address book or profile that contains an element. See FIG. 6 and related text for details.

Record—An address book entry for an associate.

Profile—A set of information about an associate, comprising one or more of the following fields: names, pseudonyms, device identifiers such as telephone numbers, email addresses, home and/or work addresses, account numbers, handles, and other personal information (more examples are provided below). A profile is often maintained by the associate.

Pseudonym—A name chosen to represent an associate. The pseudonym may consist of a moniker selected, for example, by the associate. The pseudonym may be a handle or login name for a subscribed service. It may also be an alpha-numeric or digit string, email address, the associate's real name, an account number, a telephone number, a subset of the associate's real name, a nickname, or another name used to identify the associate. In the current invention, the word “pseudonym” and the word “name” may be used interchangeably, since they are both used to identify an associate, thus the distinction is largely unimportant in the context of the current invention. In the current disclosure, we sometimes refer an element comprising a name or to a client speaking a name, however it is to be understood that the word “name” here is used illustratively and is not restricted to consisting of a person's legal name, rather it may be a full name, first name, last name, nickname, handle, pseudonym or any other name by which a person may be known or identified.

If there are a large number of associates and/or clients in an address book, it may happen that two or more associates have the same moniker, handle, or other name. In this case, we may include, as part of the name pseudonym, a department identifier, so that the pseudonym consists of a name plus a department identifier. A department identifier is a piece of information that further characterizes an associate. Two parties may have the same legal name or even the same moniker and still have unique pseudonyms.

Communication Device—software and/or hardware used to pass information between parties. In some of the examples described here, the communication device is illustratively represented as a telephone, but it is to be understood that the communication device may be a standard analog or POTS (Plain Old Telephone Service) phone, wireless telephone such as a cell phone, digital telephone, SIP phone, VoIP phone, softphone, click-to-talk application that is activated by a selection method such as clicking an icon on a web page or email or elsewhere on a computer screen, video phone (software or hardware based), PDA (Personal Digital Assistant), Wi-Fi phone, Wi-Max phone, peer-to-peer phone, a point-to-point phone, instant messaging (IM) software or hardware application, email system, voicemail system; or any other device capable of enabling communication between parties.

Device Identifier—an identifier used to reach or specify a path to a communication device. In some of the examples described here, the device identifier is illustratively represented by a telephone number, but it is to be understood that the device identifier is any identifier used to reach that device, including a digit string, a SIP address, an email address, a user name or handle, an IM handle, or other identifier appropriate for the relevant device.

Device Location—a descriptor that specifies a particular device among several. For example, if the device under discussion is a telephone, possible device locations may be “home,” “office,” “cellular,” “softphone,” etc.

Caller Identifier—a signal or alphanumeric string representing an identity of a caller. In the case of a standard telephone call, the caller identifier may be the Caller ID or ANI. In the case of a SIP or VoIP call, a caller identifier may be a SIP address or IP address. The caller identifier may also be a pseudonym, a password and/or account number, email address, serial number of said caller's communication device or software, a MAC address of said caller's communication device, biographical information, biometric information (such as fingerprint, voiceprint, or geometric information) about the caller, or other descriptor that identifies the caller. The caller identifier may be collected automatically as is typical with Caller ID, or it may be provided by the caller. Caller-provided caller identifiers may, for example, be provided by keyboard input, by way of one or more voice samples, or via DTMF input and may be provided in response to a prompt.

Profile—information pertaining to an associate. Examples of profile elements include telephone numbers (or other device identifiers), email addresses, names, pseudonyms, and any other information provided by an associate and stored in an address book. A profile has a structure similar to an address book record and may even be thought of as an address book containing a single record. Generally, a profile contains information about the party who is able to create and/or update (i.e. create information, modify information, add information, and/or delete information) the profile. See FIG. 6 and related text for details.

Indexed Element—a profile or address book element that is used to match a profile with an address book record.

### BRIEF DESCRIPTION OF THE DRAWINGS

FIG. 1 shows a sample architecture for voice dialing with an automatically updated address book.

FIG. 2 shows the steps of updating an address book and requesting an action.

FIG. 3 shows, in flowchart form, the steps of collecting voice samples from a caller and selecting and performing an action.

FIG. 4 shows details involved in updating profile information.

FIG. 5 shows an additional step of checking access privileges.

FIG. 6 illustrates an example structure of an address book and a profile.

FIG. 7 illustrates a flowchart for one embodiment of the current invention.

### DETAILED DESCRIPTION

In the following description, numerous details are set forth to provide an understanding of the present invention. However, it is to be understood by those skilled in the art that the present invention may be practiced without these details and that numerous variations or modifications from the described embodiments may be possible without departing from the spirit of the invention.

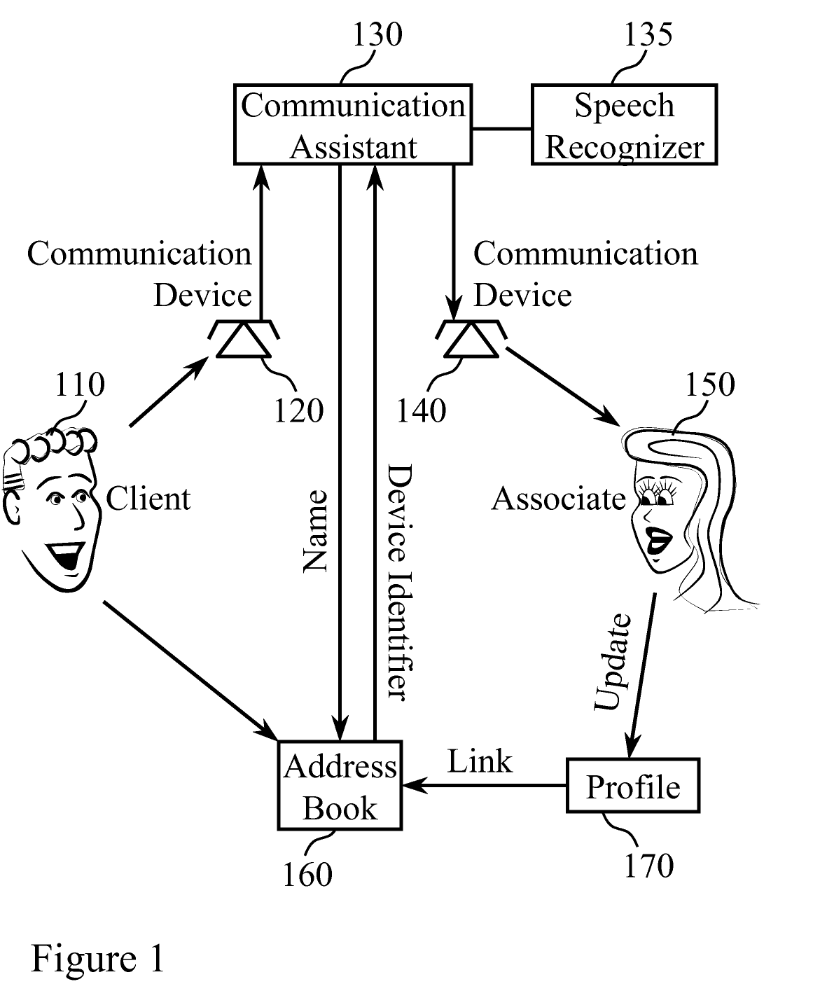

FIG. 1 illustrates a sample network architecture for one embodiment of the current invention. Client 110 has an address book 160. Address book 160 contains one or more records of associates. Associate 150 maintains his/her own personal information in profile 170. Communication assistant (CA) 130 is a system with the ability to place, receive, and connect phone calls and execute other communication actions and to access and otherwise use information in both address book 160 and, by virtue of links, profile 170. For example, CA 130 is able to pass a name or pseudonym or other information linked to an associate to address book 160 and receive, in return, other information related to said associate contained in an address book record for that associate. The separation of address book 160, profile 170, speech recognizer 135, and communication assistant 130 is illustrative; they may be combined or separate. Communication assistant 130 advantageously incorporates speech recognizer 135 (either as an integral part of communication assistant 130 or as a separate server) so that it can understand voice commands from client 110 and/or associate 150. The speech recognizer is able to match voice samples spoken by client 110 and/or associate 150 to fields in address books and profiles. Client 110 is able to correspond with communication assistant 130 and other parties via communication device 120. Associate 150 is able to correspond with communication assistant 130 and other parties via communication device 140.

For the method described in the current invention to be built and sold as a workable system, at least some of the following auxiliary systems are generally required: OAM&P (Operations, Administration, Maintenance, and Provisioning), billing (so that the service and/or equipment can be sold and revenue can be collected from customers), subscription (so that subscribers can sign up for a service, configure the service to provide desired feature options, and make billing arrangements), support (a process and a system for helping customers resolve problems, ask questions, and submit requests), testing (to validate new features and configurations), training (materials and systems for teaching customers how to configure, use, and troubleshoot the equipment and/or service), sales and marketing (methods for informing potential customers of the service and/or equipment and offering it for sale), backups (methods for archiving vital software, customer data, and other important information to help insure against loss), failure recovery (redundant systems, monitoring systems, and other methods for maintaining and/or restoring functionality in the event of loss), and observation (methods of tracking, gathering, and analyzing data and statistics on traffic load, user behavior, transaction success, subscription rates, payment, and information related to service status and history). Methods for building and deploying such auxiliary systems are known in the art.

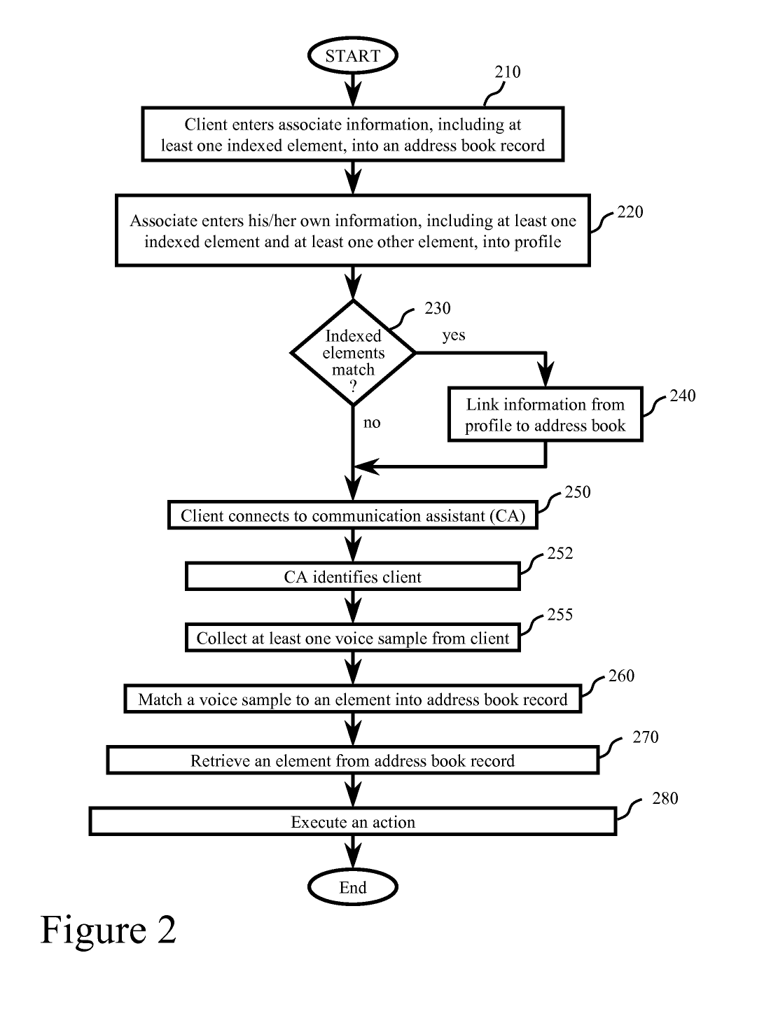

FIG. 2 illustrates the steps of an example embodiment of the current invention. Here and in subsequent figures, we sometimes refer to people and machines using numeric designations as shown in FIG. 1.

In FIG. 2, a client performs an action using the steps shown.

In step 210, client 110 creates a record for associate 150 containing at least one element (a piece of information such as phone number or email address) for associate 150 and enters this record into address book 160.

In step 220, associate 150 enters personal information in profile 170 (entering information includes updating profile if old information was previously entered). Profile elements may comprise one or more of the following: said associate's name(s); pseudonym(s) selected by said associate or assigned to said associate; pronunciation(s) for name(s) and/or pseudonym(s); telephone numbers(s) (including numbers or alphanumeric strings associated with cell phones, SIP phones, softphones, or other communication devices); SIP address(es); IP address(es); telephone extension(s); login name(s); email address(es); account number(s) or other account identifier(s); department(s); instant messaging handle(s); user handle(s) for one or more peer-to-peer phone services; radio frequency(ies) (for example, the frequency of an associate's wireless radio); radio operator license call sign(s); license plate number(s); website address(es); name(s) of employer(s); home address(es); work address(es); age, height, marital status, or other biographical information; or other information pertaining to associate 150.

A reason for including one or more pronunciations in a profile is that (1) the profile owner (associated 50) may be identified by spoken name (or pseudonym) and/or (2) the associate's name may be spoken by a text-to-speech synthesizer. Thus, associate 150 may wish to adjust the pronunciation for better accuracy and/or for a more pleasing sound. In one embodiment of the invention, a tool is provided to allow associate 150 to listen to and/or change the pronunciation. By changing pronunciations, a text-to-speech synthesizer may be able to speak the name in a more pleasing and more accurate manner and a speech recognizer may be able to more reliably recognize the name when it is spoken by, for example, client 110.

At least one profile element for associate 150 is designated as an indexed element, meaning that if the indexed element in address book 160 matches the same indexed element in profile 170, then other information from profile 170 is linked to address book 160. This strategy allows client 110 to maintain relatively complete, current information on associate 150, even though client 160 may have originally possessed only partial information.

In one embodiment of the invention, determining if two elements match comprises comparing said two elements to each other, and if said two elements are the same, then they are considered to match. If any part of one element is different from the same part of the other element, the two are not considered to match.

As an example of how an indexed element may be used, suppose client 110 knows only associate 150's email address and enters said email address into address book 160. Suppose further that associate 150 enters his/her email address, name, and telephone number into profile 170. Since the email address in address book 160 matches the email address in profile 170, the record in address book 160 is updated with information from profile 170. In this example, the associate's name and phone number are linked from profile 170 to address book 160 so that client 110 can, for example, call associate 150 using voice dialing by saying associate 150's name.

It is understood that associates may not wish to share personal information with everyone, so provisions are optionally implemented that enable associates to designate profile elements as private, semi-private, readable, or encrypted, and to restrict or allow access to specific individuals or groups. (Security designations “private,” “semi-private,” “readable,” and “encrypted” are discussed further below.)

Returning to FIG. 2, in decision block 230, it is determined whether an indexed element in address book 160 matches an element contained in a comparable field (e.g. we would usually expect both elements being compared to reside in fields of the same type so that we compare an email address with another email address, etc.) in profile 170.

In step 240, if block 230 declares a match, information is linked from profile 170 to address book 160.

In step 250, client 110 uses communication device 120 to connect to communication assistant 130. The connection takes different forms, depending on the type of communication device at hand. If the communication device is a telephone, connecting to communication assistant 130 may consist of placing a call by, for example, dialing a number. If the communication device is a click-to-talk application, for example, the appropriate connection method may be to establish a VoIP link between the client's computer and communication assistant 130. It is to be understood that a variety of communication devices and connection methods may be employed to connect client 110 to communication assistant 130 via communication device 120 without departing from the spirit of the current invention.

In step 252, communication assistant 130 discovers the identity of client 110. Step 252 is useful in insuring that the correct address book, i.e. the one owned by (or otherwise associated with) client 110, is used in subsequent steps. The step of identifying client 110 may comprise of one or more of the following: collecting a name or pseudonym from client 110; collecting a telephone number from client 110; collecting an account number from client 110; collecting an encrypted number; collecting a password or pass phrase from client 110; collecting a PIN (personal identification number) from client 110; determining a caller identifier (Caller ID, ANI, or IP address, or other identifier as defined under “Caller Identifier” in definition section above); determining the DNIS (dialed number) used by client 110; receiving a call from client 110, disconnecting, and calling client 110 back; or collecting personal information such as birth date or a billing number from caller 110; It is to be understood that other means of identifying and/or confirming the identity of individuals are known in the art and may be used in the context of the current invention. In step 255, communication assistant 130 collects a voice sample from client 110. Communication assistant 130 may elicit the voice sample from client 110 by playing a prompt such as “What would you like to do?” or “Please say a name,” though the prompt is optional. Once the client speaks, the voice sample is input to a speech recognizer for identification. For example, if the communication assistant is configured to perform name dialing, it may ask the client for a name, then compare the voice sample to the contents of the name field in some or all records in the address book to find a match, thus identifying the associate the client wishes to call. The client may provide other information in this first voice sample or the client may provide additional information in subsequent voice samples with further direction from prompts, such as whether the client wants to make a call or send a message and which of several associate's phones to use.

In step 255, the voice sample from client 110 may identify associate 150 by providing an associate identifier such as a spoken name. A spoken name may be associate 150's real name, a pseudonym, a digit string, or other phrase that identifies associate 150. In on embodiment of the invention, client 110 identifies associate 150 by saying a name. In alternative embodiments of the invention, client 110 dials a digit string, types a character string, or selects a location on a display. Said selecting a location may constitute a mouse click, pointing with a pen input device, touching a touch screen, or other means of selecting or entering an identifier for said associate. As an illustrative example of this alternative embodiment, in the case of a digit string, client 110 may optionally dial the string, or, if client 110 has access to an alphanumeric keyboard or equivalent, client 110 may alternatively type the associate's name as an alphanumeric string. We refer to the spoken name or pseudonym, digit or alphanumeric string, or other identification of the associate as an associate identifier.

In step 260, a speech recognizer uses the client's voice sample to select a record in a client's address book by comparing the voice sample to a field in each record and selecting the record containing the field that best matches a voice sample. A voice sample is considered to match an element if the voice sample contains the spoken form of the element. The voice sample may contain other words or sounds, but it we declare a match if it at least part of the contents consists of the spoken form of the element. For example, if an element is the text string “Michael Metcalf” and a voice sample consists of the spoken words, “Uh, Michael Metcalf please,” then the voice sample and the element match.

An illustrative method for determining if a voice sample matches an element is as follows: At least one element in each address book record is designated as a vocabulary element. (We advantageously define a vocabulary element as an element that is (1) used to construct a vocabulary list for a recognizer grammar and (2) matched against a voice sample.) A grammar is constructed from a set of vocabulary elements, usually one vocabulary element from each address book record. For example, if a person's name were used as a vocabulary element, then a name would be copied from each address book record into a name list grammar. The voice sample is provided as input to a speech recognizer. The speech recognizer compares the voice sample to the set of possible vocabulary options specified by the grammar and determines a best match. A vocabulary element may be the same element as the indexed element.

In one embodiment of the current invention, client 110 identifies associate 150 by speaking a name. In an alternative embodiment, client 110 identifies associate 150 by speaking one or more of the following: said associate's name; part of said associate's name; a pseudonym selected by said associate or assigned to said associate; a telephone number; a telephone extension; a digit string; a login name; a region selected, using a pointing device, on a display; an email address; an account identifier represented by a number or alphanumeric string; a department identifier; a pseudonym and a department identifier; a name and a department identifier; a SIP address; an IP address; an instant messaging handle; a user handle for a peer-to-peer phone service; a radio frequency; a radio license call sign; a website address; and other information pertaining to associate 150.

In step 270, communication assistant 130 maps the recognized voice sample to a device identifier using address book 160. In one illustrative embodiment of the invention, client 110 says the name of associate 150, the name is recognized by communication assistant 130 (possibly with help from a speech recognizer), the address book record of associate 150 is queried, and associate 150's device identifier is retrieved from said associate's record.

In one embodiment of the current invention, said device identifier is a telephone number. In an alternative embodiment, said device identifier is one or more of the following: a telephone number; a device location; a digit string; a SIP address; an IP address; an email address; a user name or handle; an IM handle; a radio frequency; a URL; a URI; a web site address; a peer-to-peer or point-to-point communication handle; a telephone extension; or any other tag or locator information that identifies a communication device used by associate 150.

In step 280, communication assistant 130 uses the device identifier to establish communication with associate 150. In one embodiment of the invention, said established communication is a telephone call via an analog, wireless, VoIP, or digital line. Once associate 150 answers the call, client 110 and associate 150 are free to communicate. In an alternative embodiment of the invention, said established communication is one or more of the following: sending a voicemail message; sending a text message such as an SMS (Short Message Service) message or email message; sending an email message with an attached audio file containing a voice message; connecting to an instant messaging application; connecting to a SIP phone, softphone, or other VoIP phone; connecting to a click-to-talk application; connecting to a PDA; connecting to a peer-to-peer phone, connecting to a point-to-point phone; connecting to a Wi-Fi or Wi-Max phone; and using an optical or electronic switch to establish voice and/or video communication.

One utility of the embodiment shown in FIGS. 1 and 2 is to allow client 110 to maintain a name dialing application with current contact information by entering only email addresses from associates. The email addresses are mapped to names and telephone numbers in address book 160 so that client 110 need only speak an associate's name, and the number is dialed automatically. It is to be understood that, in this and other examples, the telephone could alternatively be a SIP phone, IM software application, or other communication device (see definition of communication device above) and/or the email address could also be different element without departing from the spirit of the current invention.

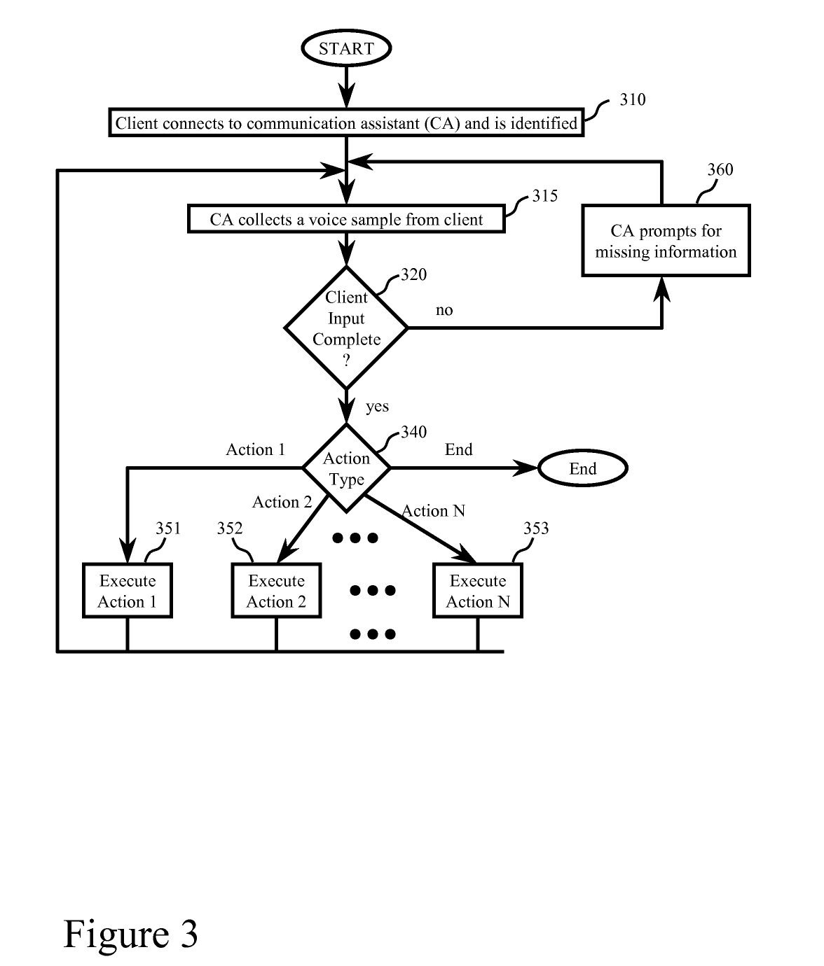

FIG. 2 illustrates an embodiment of the invention where client 110 is able to execute an action, for example, placing a phone call. FIG. 3 illustrates an alternative embodiment where client 110 may choose one or more of several actions. The client may either specify the action as part of a response to the initial prompt or as part of one or more responses to subsequent re-prompts. In some cases, certain information is implicit and need not be specified by a client, for example, if the associate has only one phone number, it may not be necessary for the client to provide the device location (since there is only one).

For convenience and brevity, much of the disclosure of the current invention describes placing telephone calls as examples, but it is to be understood that this action is illustrative, that other actions are included within the scope of the invention. We use the terms “establish communication” and “connect to” to represent actions and we give examples of email and telephones, but several actions are possible, including ask for help; forward calls; look up an email address; look up a phone number; update a profile; update someone else's address book; place a call; place a call using “call blast” (defined below); place a call using a hunt group; place a videophone call; place a VoIP call; send voicemail or email; listen to voicemail or email; reply to voicemail or email; administer (delete, forward, save, etc.) voicemail or email; send an instant message; send an SMS message; send information to a device or an account; change privacy settings for profile elements; and disconnect from a communication assistant. One action of interest is to retrieve information from an address book using recorded prompts or text-to-speech. A client, may for example say, “Get an email address for David Thomson,” and a communication assistant will retrieve David Thomson's email address and read it to the client. Similarly, a client may request telephone numbers and other information. A client may also request to have address book information sent to a communication device. If a client says, “Send information to my cell phone,” and the client has just listened to retrieved information (as in the previous example of David's email address), the communications assistant understands that it is expected to forward the most recently retrieved information as a text message to the client's cell phone. The client can also specify the information and/or the destination, as in, “Send Michael Metcalf's telephone number to Tracy Roberts's work email” and the request will be executed.

We note here that useful action is the objective. Clearly, the mere act of collecting a voice sample could be considered an action, but it may not necessarily be useful. We define a useful action as one where a client provides information that may be useful to the client or to someone else or where the client receives information. If information is provided to a machine (a computer, for example) so that the machine can perform an action that is useful to a person, then that information is considered useful. Useful actions include text communication, text messaging, voice communication, voice messaging, checking or affecting system configuration options and actions listed in the previous paragraph.

The action described above as “send information” refers to the action of sending information about the person using the service (“the user”) or about another person for whom the user has access. The information may be sent to the user's own email, voicemail, cell phone, pager, IM application, or other device or application capable of receiving such information. Alternatively, the information may be sent to someone else's email, voicemail, cell phone, pager, IM application, or other device or application capable of receiving such information. For example, the user could ask for an associate's email address, then further instruct a communication assistant by saying, “Send this email address to my cell phone,” and the email address would be sent to the user's cell phone as an SMS message.

In addition to being able (and sometimes required) to specify one or more of a group of actions, certain useful actions may require more information. For example, if a client says, “Call Tracy Roberts,” and Tracy has several phones, then additional input may need to be collected from client 110.

An illustrative embodiment of the invention where a client may be re-prompted for missing information such as action and device location is shown in FIG. 3. FIG. 3 begins after client 110 and associate 150 have entered prerequisite information into address book 160 and profile 170, respectively and address book 160 has been updated (if appropriate). In other words, blocks 210-240 in FIG. 2 have already been completed. FIG. 3, then, is an alternative embodiment of the current invention to that shown by blocks 250-280 in FIG. 2.

In block 310, a client is connected to a communication assistant and is identified by said communication assistant. The identification part of step 310 is described in more detail in text associated with step 252 in FIG. 2.

In block 315, a first voice sample is collected from client 110.

In block 320, if the first voice sample lacks information necessary to execute a useful action, client 110 is prompted in block 360 to provide the missing information and another voice sample is collected in step 315. Steps 315, 320, and 360 are executed as many times as necessary to collect complete input command instructions.

Said missing information may include one or more of the following: an associate identifier, for example, Tracy Roberts (name), CuteFunGirl (moniker), etc.; an action (e.g. make a call, look up an email address, etc.); or a device location (e.g. home phone, work phone, or cell phone). A device location is a differentiator that distinguishes similar devices in a class, where a class may be telephones, email addresses, etc. If a client says, for example, “Call Michael Metcalf,” and Michael has three telephones, then the client may be prompted to provide a device location, for example, “home,” “work,” or “mobile.”

If necessary information is missing, but is implicit, it is not collected from client 110. For example, if associate 150 has only a work email address, it is not necessary for client 150 to specify whether to use a home or work email address.

Another case where it is not necessary to collect missing information is if the device location is not specified, but the system used to place calls (such as a communication assistant, softswitch, or other network machine) is configured to try all device locations simultaneously (we call this “call blast”) or one at a time (we call this a “hunt group”). The word “simultaneously” does not necessarily indicate that the call attempts occur at exactly the same time, rather that they are initiated at approximately at the same time (usually within less than ten seconds of each other) so that they are likely to be ringing simultaneously. If call blast is active and an associate has multiple telephones, all phones are called simultaneously and the phones continue to ring until the client disconnects (hangs up, asks the CA to stop trying, or clicks or presses a disconnect button), until a phone is answered, or until the call goes to voicemail. If a hunt group is active, phones are called one at a time until an associate answers, all phones have been called, the client disconnects, or the call goes to voicemail.

In block 320, if preceding voice sample(s) collected so far contain enough information to proceed with an action, processing continues to block 340.

In block 340, a determination is made regarding which action is to be taken. In one embodiment of the invention, there may be N possible Actions, numbered from 1 to N in FIG. 3, corresponding to blocks 351 through 353. (Any actions between block 352 and 353 are not shown.) If it is determined that Action 1 is needed, processing proceeds to block 351, and so on up through Action N and block 353. Action 1 through Action N are any of the actions listed above (ask for help, etc.). If the appropriate action is to end the connection (for example if the client says “Goodbye”), communication assistant 130 disconnects from client 110 and processing ends.

Once an action is completed, if communication assistant 130 is configured to allow further requests, processing returns to block 315. If further requests are not allowed, processing ends, allocated resources are released, and any existing communication paths are torn down.

In an optional variation on the current invention, if the communication assistant is unsure about what is spoken at any point (including the initial voice sample and all subsequent voice samples), the communication assistant may ask the client to repeat (prompt the client to say it again) or confirm (for example by saying “yes” or “no”) the voice sample. If the communication assistant cannot understand the voice input, the client may be re-prompted.

A conversation illustrating confirmation and device location prompting is:

CA: “What would you like to do?”

Client: “Send an email to David Thomson?”

CA: “To which device location, his home or work email address?”

Client: “Work.”

CA: “Did you want to send an email to David Thomson at work?”

Client: “Yes.”

CA: “I didn't understand you. Please repeat.”

Client: “Yes.”

Notice in the above example, the communication assistant was confident that it recognized “Send an email to David Thomson,” so it was unnecessary to confirm, but the communication assistant was not confident about the recognition accuracy on the word “work,” so it asked the client to confirm by saying “yes” or “no.” Note also that the CA could not understand the first “yes,” so it re-prompted said client. Note also that David has two email addresses. If he only had one email address, it would not be necessary to prompt the client for a device location.

In our discussion so far, we have not yet specified whether information is public and how it might be restricted. Associates listed in an address book may wish for their information to be protected, may wish to grant the access privileges only to specific individuals or groups, and may even wish to later revoke such privileges. In one embodiment of the current invention, all profile information is available to a client. In a first alternative embodiment, some information is designated as readable, meaning that the client can read it, and some information is private, meaning that the client can neither read nor use the information. In a second alternative embodiment, information is designated with multiple security levels, where security levels define access (read, write, and use) characteristics. These levels may include, but are not limited to, readable, private, semi-private, and encrypted. Readable information can be read and used by a client. Private information cannot be read or used by a client. Semi-private information can be used, but not read, by a client. If an email address is semi-private, for example, a client can use the email address to send email to an associate, but the client cannot look up and read the email address in an address book. As another example, if a telephone number is semi-private, a client can use the number to call an associate, but the client cannot look up and read the telephone number. Encrypted information may be read by a client, but is encoded in such a way that the un-encrypted form of the information cannot be easily deciphered and/or is encoded in such a form that the information can only be used under certain conditions.

Many methods exist in the art for encrypting information and for using encrypted information, but we illustrate here how encryption may be used in the context of the current invention using two examples:

(1) An associate has a communication device that may be reached via multiple device identifiers. For example, the communication device may be a VoIP telephone reachable by any of 1000 IP addresses. When said associate wishes to grant access to his/her communication device, said associate gives one of said device identifiers to a client and configures said communication device to accept calls placed using the device identifier given to said client. Inbound calls arriving with said identifier given to said client are accepted, but inbound calls arriving with an identifier not given to a client are rejected. If Client X has been given a device identifier that reaches said associate's said communication device and said associate wishes to block Client X, said associate configures said communication device to reject calls arriving with the device identifier given to Client X.

(2) An associate encrypts a device identifier using any one of many encryption algorithms known in the art. For example, said associate may append a random 10-digit string to the end of said associate's 10-digit telephone number to produce a 20-digit string. Said 20-digit string is used as a seed for a random number generator, with a key known to said associate, to generate a new 20-digit string. Said new 20-digit string is entered in a profile field as an encrypted telephone number. A client may read and save said encrypted telephone number, but is unable to use it except with equipment capable of decrypting said number. A dialing system, for example, with decryption may accept a call from said client, confirm said client's identity through a caller identifier or password, then use said key provided by said associate to decrypt said encrypted number and place a call to said associate. Other encryption strategies are known in the art and may be used in the context of the current invention.

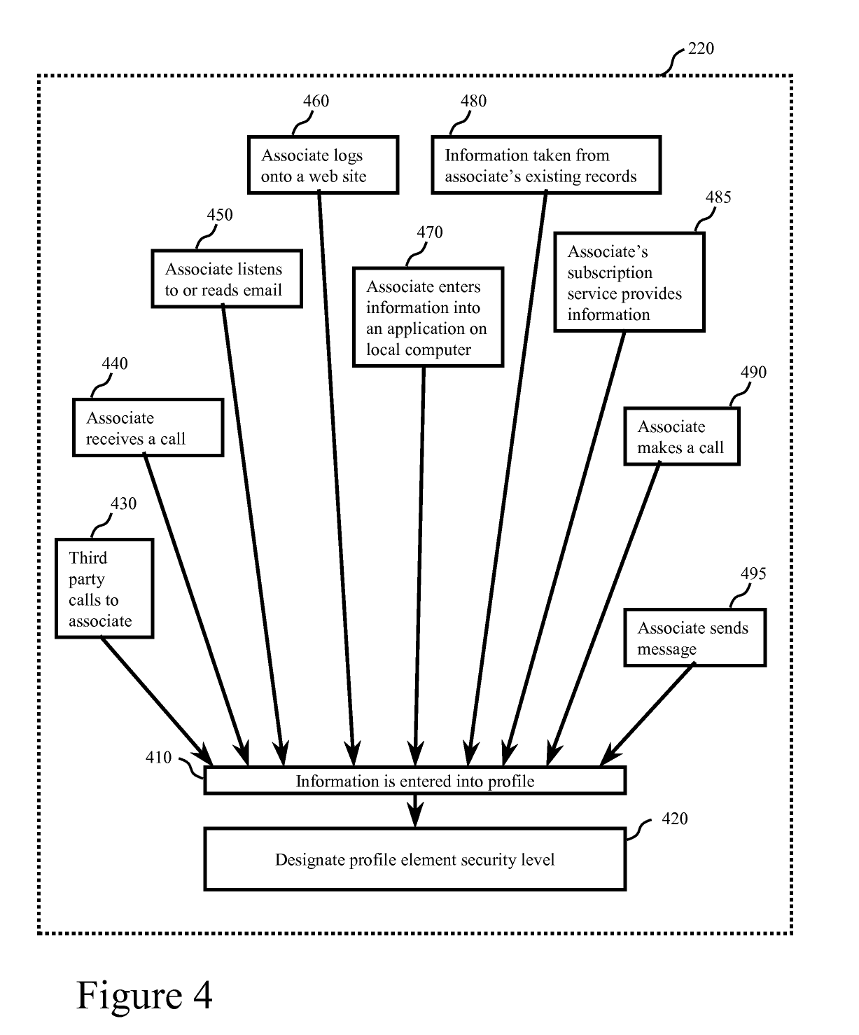

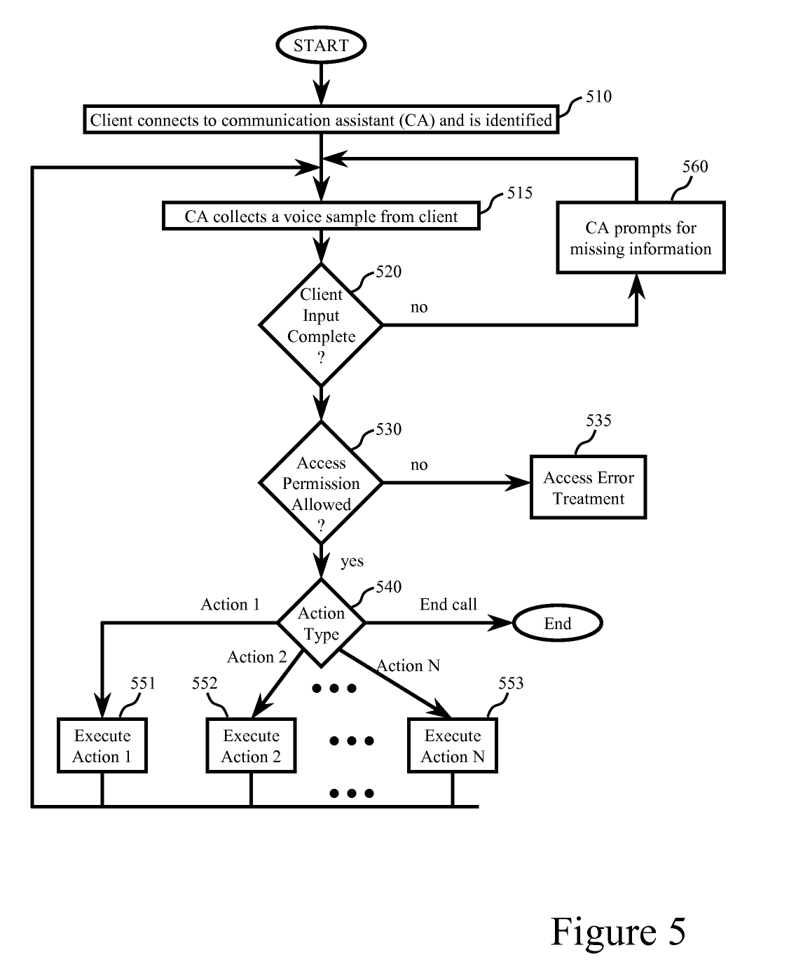

We now consider one example (of many possible arrangements) to further illustrate the difference between readable, private, semi-private, and encrypted. Suppose associate 150 specifies that, for a given client, her work number is readable, her email address is private, her IM handle is encrypted, and her home number is semi-private. Said client can now look up said work number and write it on a piece of paper as a permanent record. Said client can neither look up said associate's email address nor send said associate an email message. Said client cannot look up said associate's home telephone number. Said client can call said associate at home by using a communication assistant (which is able to look up said associate's home number but will not pass it on to the client) and by providing a piece of known information such as said associate's pseudonym to said communication assistant. Said client can send said associate an instant message if said client uses an instant messaging application that is capable of decrypting the IM handle, but said client has no easy way of obtaining the unencrypted IM handle. Illustrative details on privacy aspects of the current invention are illustrated in FIGS. 4 and 5.

FIG. 4 provides details for block 220 in FIG. 3 and also treats the case where an associate protects personal information by assigning privileges for certain profile elements to specific clients. In block 410, associate 150 populates one or more fields in his/her profile. In step 420, associate 150 indicates which fields are available and at what level (for example, readable, private, semi-private, or encrypted) for a given client.

In a first embodiment of the invention, associate 150 designates an access level for a given client for each profile element. Since an associate may have many profile elements and many clients, it may require a lot of time to make an access decision one at a time for every field for every client. Therefore, in a second embodiment of the invention, we optionally construct one or element groups and/or client groups to simplify the job. In this second embodiment, associate 150 grants levels of access to clients by making security decisions for groups of elements and groups of clients instead of for individual elements and clients. (Groups can be as small as one element or one client.) An associate is allowed to divide profile elements into element groups (or, optionally, the profile elements are already divided into groups) and assign a security level to a group such that elements in the element group inherit (i.e. are set to be the same as) the security level of the element group. Likewise, an associate can divide clients into client groups (or, optionally, clients are automatically divided into groups) and assign a security level for a given element or group of elements to a client group such that clients in the client group inherit the security level of the client group. Using this method, a client can set a first security level for one or more groups of elements for at least one first group of clients and a second (different from the first) security level for said one or more group of elements for a at least one second group of clients.

One implementation of this second embodiment is to allow an associate to designate a first security level for a first group of home information and a second security level for work information.

An example of how rules are used to grant access levels (in block 420) is as follows: Client 110 belongs to a specific department or is assigned to a department by associate 150. Profile elements are divided into groups with similar security levels. Associate 150 grants access privileges to a department for a given field group so that clients in said department inherit the specified privilege for each field in said field group.

A specific example illustrates the strategy of the previous paragraph. Suppose work information (work phone number, work email address, etc.) constitutes a field group called “Work Info” and home information (cell phone number, IM handle, home address) belongs to field group “Home Info.” Clients are divided into “Business Colleagues” and “Friends.” An associate grants “readable” access for “Work Info” to clients in the group “Business Colleagues.” Said associate grants “semi-private” access to “Home Info” for clients in both “Business Colleagues” and “Friends.” Clients and departments where associate 150 does not specify access receive default treatment, for example “private,” meaning that these clients and departments are unable to read or use the unspecified fields.

It is anticipated that other designations, in addition to readable, private, semi-private, and encrypted, may also be used. Other methods of limiting access to one or more populations are know in the art and may be employed here (block 420) without departing from the spirit of the invention.

Within the scope of the current invention, there are many ways an associate may update (meaning to create, add, delete, or modify) profile information. Updating profile information also includes the step of granting access permissions to clients. In one embodiment of the invention, said associate enters profile information using a combination of DTMF and/or voice. Various methods tend to be more convenient and preferable than others under different circumstances. A few of these update methods are illustrated in FIG. 4. In one embodiment of the current invention, the associate updates profile information via one or more of the following methods:

1—Update via incoming third-party calls (Block 430): A third party calls the associate and takes said associate's profile information and enters it for him/her. An example of said third party might be a telemarketer trying to sell a service to said associate.

2a—Update in association with inbound calls using voice and/or DTMF (Block 440): The associate receives an inbound telephone call from a caller. This caller may be a client. At some point during, before, or after the call, said associate either asks an automated system (such as a communication assistant) to update the profile or is invited and accepts. In one simple example of this second method, the associate denies access to a telemarketer who places an inbound telephone call by ending the call with the command to a communication assistant, “Designate all fields as private for this caller.”

2b—Update via processor-based, database-connected communication devices on an inbound call (Block 440): The associate and/or said client have communication devices that are capable of accessing and exchanging profile and/or address book information. As an example of this alternative embodiment, said client and said associate are using processor-based phones, where said associate's phone has access to said associate's profile and said client's phone has access to said client's address book. With a spoken command, mouse click, screen tap, button press, or other input to their respective devices, said client and/or said associate agree to exchange information, whereupon said communication devices copy or link said associate's profile with said client's address book.

3—Update during an email reading/listening session (Block 450): The associate is reading listening to an email message over a telephone or using a computer and, through a combination of voice commands and/or button presses, updates profile information before, during, or after the process of listening to or reading the email.

In one simple example of this third method, the system playing email over the phone tells the associate that the person sending the email does not have access to the associate's profile and asks if the associate wishes to share it. If the subscriber says “yes,” the subscriber's profile is linked to the address book owned by the sender of said email message. In a second simple example of this third method, the associate receives a request from a client to update the associate's address book. The associate sends a return message with the requested information. An automated system extracts the requested information from the return message and updates the client's address book.

4a—Update via a web site in response to an email request (Block 460): In response to an request delivered via email, the associate visits a web site and enters personal information into the web page. This information is then saved in the associate's profile.

4b—Update via a web site (Block 460): In one embodiment of the invention, said associate visits said web site in response to a request from a client or other entity. For example, said request may arrive via email, voice mail, paper mail, or a telephone call and may include a link to said web site.

4c—Update via a web site in response to a suggestion by an email application (Block 460): In another embodiment of the invention, a client receives an email message from an associate and the software providing email service (such as an email client or web page) notices that said associate's profile information is missing from said client's address book and prompts said client to send a message to said associate, asking for an update. Said message to said associate advantageously contains a link to a web site used for updating profile information, and, in particular, providing said client access to said associate's profile information.

5—Update via a local software application (Block 470): The associate enters profile information into an application running on said associate's computer. Said profile information is then uploaded to an address book, where it is available to a client. The computer may be a desktop computer, a handheld device such as a PDA or cell phone, a video game, a laptop, or any other processor-based machine capable of updating said profile.

6—Update extracted from existing records (Block 480): The associate has profile information residing in an existing database such as company records, account records with a communications carrier, employment records, records associated with a subscription-based service, or government records. Information from one or more of these records is linked (hopefully with permission) to said associate's profile. The existing database may centrally located (in a telephone office or corporate IT center, for example), or may be part of a software application or database (for example, Microsoft Outlook) on the associate's local computer such as a laptop or other computer at home or at work. The act of extracting profile information from the local computer may comprise running a software application that retrieves profile information from the local computer and uses the retrieved information to update the associate's profile.

7—Update based on extension of an existing service profile (Block 485): The associate has an account with a first service and has a first profile associated with said first service. Information is linked from the first profile to a profile that is used in the context of the service described in the current patent. Alternatively (and, for most purposes, equivalently), the first profile is used directly (instead of linking) in the context of the service described in the current patent. For example, an associate may subscribe to telephone service from a carrier and said carrier may offer said associate a subscription to a voice dialing service. If said associate accepts, said carrier merely connects said associate's existing profile to said voice dialing service and the profile information is automatically available to clients and/or associates.

8a—Update in association with outbound calls using voice and/or DTMF (Block 490): This method is identical to method #2a, above (block 440), except that, instead of receiving a call, said associate calls a client and either reaches said client or reaches said client's voicemail. Steps for updating profile information are otherwise as described in method #2a for block 440.

8b—Update via processor-based, database-connected communication devices on an outbound call (Block 490): This method is identical to method #2b, above (block 440), except that, instead of receiving a call, said associate calls a client and either reaches said client or reaches said client's voicemail. Steps for updating profile information are otherwise as described in method #2b for block 440.

8c—Associate calls a communication assistant or other intelligent network system such as an IVR platform. In this method, an associate may have an account as a client with a communication assistant or the associate may otherwise have access to a system that allows profile updates. The associate may change access numbers, forwarding numbers, email addresses, etc., by voice commands such as, “Forward my calls to home,” “Change my virtual extension to 1-630-852-3537,” or “Do not disturb” (erases or hides telephone number elements). By interacting with a communication assistant or other system, the client is able to change his/her profile, nominally using voice commands and/or DTMF, thus precipitating an update to clients' address books.

9—Update by sending email, IM, or other message (Block 495): In this method, the associate sends an email, IM, voicemail, or other message to a client or to an automated system, optionally in response to an update request. Said message contains profile information. This profile information is used to update said associate's profile. In one embodiment of the invention, a client sends a request (by email, IM, voicemail, SMS, or by other means) to one or more associates (the list of associates receiving said request could, for example, be all or a subset of associates listed in said client's address book) asking for updates to the associate's or associates' information; the associate (or a software or human proxy for the associate) responds by either sending the requested information to the client or by updating the associate's own profile; and the new information is incorporated into the client's address book, either manually or by means of a software application that automatically uses the new information to update the address book.

FIG. 3 illustrates one embodiment of the invention where we assume that client 110 has access to relevant profile information. However, as shown described above, certain implementations of the invention allow associates to protect information by granting or denying permission. FIG. 5, a modified version of FIG. 3, illustrates another embodiment of the invention where access levels are checked and actions are denied if a client lacks necessary permissions.

The explanation of blocks in FIG. 3 applies to comparable blocks in FIG. 5. (Comparable blocks are those where the last two digits of the block number match. For example, block 560 performs the same function as block 360.)

Two new blocks in FIG. 5 are blocks 530 and 535. Once it is determined in block 520 that enough information has been collected from client 110 to perform a task, a permission check is performed in block 530. If it is determined that client 110 has sufficient access permission to read and/or use fields in associate 150's profile needed to perform said task, processing proceeds to block 540 and then to action blocks 551-553. If client 110 lacks adequate privileges, for example if associate 150 has designated fields private or semi-private and the action specified by client 110 requires semi-private or readable access, respectively, then processing proceeds to block 535 for error treatment. Appropriate error treatment depends on the service, business model, characteristics of the subscriber population and other factors, and may include one or more of the following: play a disconnect message and drop the connection; return to block 510 and invite the client to select a different request; offer to send associate 110 a message requesting greater access; or suggest an alternative action.

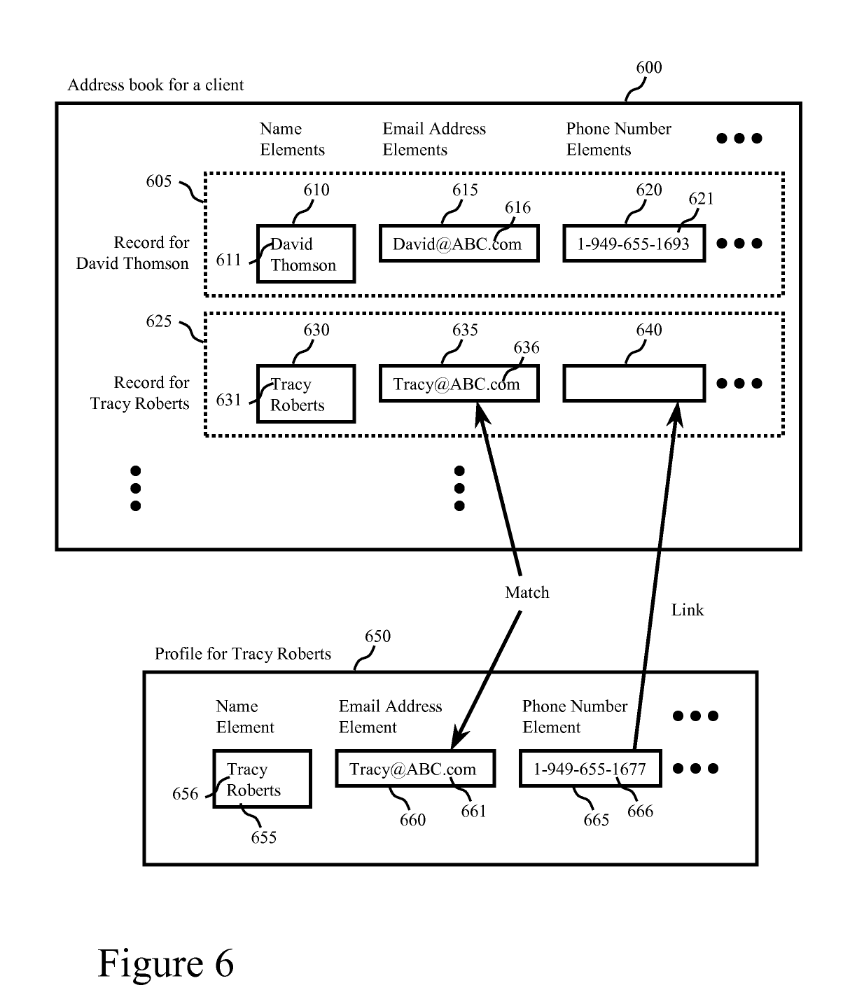

FIG. 6 illustrates an example structure of an address book and a profile. The specific elements, numbers of elements, and contents of fields are merely illustrative. As indicated by the “ . . . ” notation, more elements may be included in records and in the profile and more records may be included in address books. In the example of FIG. 6, two records are shown for address book 600 and three fields are shown for each record and for profile 650.

We refer to a piece of information in an address book or profile as an element. We refer to the location where an element is kept as a field. A field is a place, such as a computer register or disk file or memory location, where an element may be stored. For example, a telephone number is an element, and it is stored in a telephone number field. A field may contain an element or it may be empty. In FIG. 6, elements 611, 616, 621, 631, 636, 656, 661, and 666 are stored in fields 610, 615, 620, 630, 635, 655, 660, and 665, respectively. Field 640 is empty.

In the example of FIG. 6, a client has an address book 600 with two records shown, one (record 605) for associate David Thomson and one (record 625) for associate Tracy Roberts. In one embodiment of the invention, records in address book 600 are created manually by the client. In an alternative embodiment, address book records are extracted automatically from directory listings, corporate employee records, or from other contact databases or applications (such as Microsoft Outlook).

Record 605 contains three fields, each containing three elements as follows: Name field 610 contains name element 611, the name being “David Thomson. Email address field 615 contains email address element 616, the email address being David@ABC.com. Phone number field 620 contains phone number element 621, the phone number being 1-949-655-1693. Address book record 625 has a similar structure to that of record 605 except that the information relates to associate Tracy Roberts and that there is no phone number initially listed in phone number field 640.

Elements in address book 600 may added or updated manually by a client typing in each element, they may be added automatically by importing information from another address book, or they may be extracted from another directory such as a telephone listing database or corporate employee records. Other methods of manual, automated, or batch-mode (creating or updating multiple address books at once) populating an address book may be used within the scope of the current invention. By “adding” an element to a record, we mean that we populate a field with information (the element or elements). If the field already contains information, the old information is overwritten by the new element.

Profile 650 contains information pertaining to associate Tracy Roberts and is nominally populated with information by said associate, though other manual, automated, and/or batch-mode methods may also be used. Elements 656, 661, and 666, contained by fields 655, 660, and 665, respectively, represent Tracy's personal information.

In accordance with one embodiment of the current invention, element 636 is compared to element 661, or, equivalently, the contents of field 635 are compared to the contents of field 660. Since fields 635 and 660 and elements 636 and 661 are used to find matching profiles and address book records, they are called indexed fields and indexed elements, respectively. If elements 636 and 661 match (and in the example of FIG. 6 they do), then phone number element 666 is linked to field 640 of record 625. The link may be accomplished, for example, by means of a software pointer, the action of copying element 666 into field 640, or by configuring fields 640 and 665 to share memory space. By linking information from associates' profiles to a client's address book, the client's address book 600 is kept up-to-date to the extent that associates keep information current in their own profiles. Note that the client does not depend completely on associates to keep information current, since the client can use other means (manual population, automatic population from another address book or software application such as Microsoft Outlook, etc.) to add information to the client's address book, in which case information added by said other means is used unless or until it is updated from associates' profiles.

Once a link between fields 665 and 640 is set up, the client may request one ore more actions that require access to element 666. For example, the client may connect to a communication assistant and say, “Call Tracy Roberts.” The client's voice sample is compared to elements 611 (“David Thomson”) and 631 (“Tracy Roberts”) and found to match element 631. The communication assistant then retrieves the number from the phone number field (field 640, or, in the case of a link comprising a software pointer, field 665) in the record (record 625) with the matching element and dials the number, which in this example is 1-949-655-1677.

In the example of FIG. 6, the phone number elements are linked but the name elements are not. This is merely illustrative. Depending on the application, some or all elements in a profile may be linked to an address book. For example, for voice dialing, it is useful to link phone numbers. For looking up information about an associate, it is convenient to link all information (at least that information that the associate has designated as readable). For sending email, it is useful to link email addresses. In one embodiment of the current invention, all information from a profile, except possibly the indexed fields (the two fields used for matching which, by definition, if linking occurs, are already the same), is linked to an address book. In an alternative embodiment, a subset of fields in a profile are linked to an address book.

In a typical implementation of the current invention, there may be multiple clients, each with an address book, and multiple associates, each with an address book. If clients are allowed to create their own address books (a counter example would be a firm that provides employees with an address book containing only records for other employees in the firm), then each address book may contain a different set of records. A given profile, then, may be linked to multiple address books, but not necessarily all address books in the system, since each address book may or may not include a record for a given associate. A profile may be linked to multiple address books, so that when the profile is updated, many address books may be consequently updated. In one embodiment of the current invention, if a profile is updated with new information, all address book records to which said profile is linked will be updated with the new information, excluding possibly elements that have been marked as private or semi-private. In the case of private or semi-private information, some address books may be updated and some address books may not be updated, depending on the permissions set by the profile owner for the given address book owner.

We speak of the profile as being “owned” by an associate and an address book as “owned” by a client, though it is possible that an address book or profile is technically owned by a subscription service, employer, or other entity. We also speak of an associate as being the one to update the profile and a client as being the one to maintain an address book; however, in some implementations, a 3^{rd} party or a software application may do the actual update. For example, an associate may be a member of a company, the associate may turn in forms containing personal information to a central company office, and a data entry clerk may accordingly update the associate's profile by proxy. In the current disclosure, we use the terms “own” and “owner” for convenience and we illustratively speak of clients and associates as maintaining their respective address books and profiles, but it is to be understood that ownership and maintenance may be by proxy, using automated systems, or performed indirectly without departing from the spirit of the invention.

We speak of an address book as being “owned” by a client; however, ownership does not necessarily mean that the client has full access to all information in or linked with the address book. If an associate makes information private, semi-private, or encrypted, the client may be restricted from reading certain fields. In fact, if software pointers are used instead of copying information from profiles to records, some information may not even literally be in the address book, rather information may be stored in profiles and only available via pointers.

One example of how semi-private information may be protected is to keep semi-private information in an associate's profile. (Keeping semi-private information in a profile, not in an address book, and providing pointers to link the information may be more secure than keeping the information in an address book, even if the address book is maintained centrally, because the client might otherwise be able to synchronize the central address book with an address book on the client's personal computer and thus gain access to information in the address book.) If a client wants to call an associate, for example, the communication assistant can retrieve the telephone number from associate's profile, and, without revealing the number to the client, call the associate at the retrieved telephone number. The associate's information may appear as if it were in the address book, but technically be located in a linked profile.

Note that the client can sometimes call an associate, or cause other actions requiring address book information, with or without links. Suppose associate David Thomson does not have a profile or has a profile with incomplete information or has made his profile information private so that address book record 605 cannot be linked with David's profile information. The client can still say, “Call David Thomson,” and a communication assistant can dial the existing number (1-949-655-1693) specified by element 621 contained in field 620. If David Thomson later makes his profile information available, field 620 may be updated with a new telephone number and the old number (1-949-655-1693) will be replaced by the new number in David Thomson's profile.

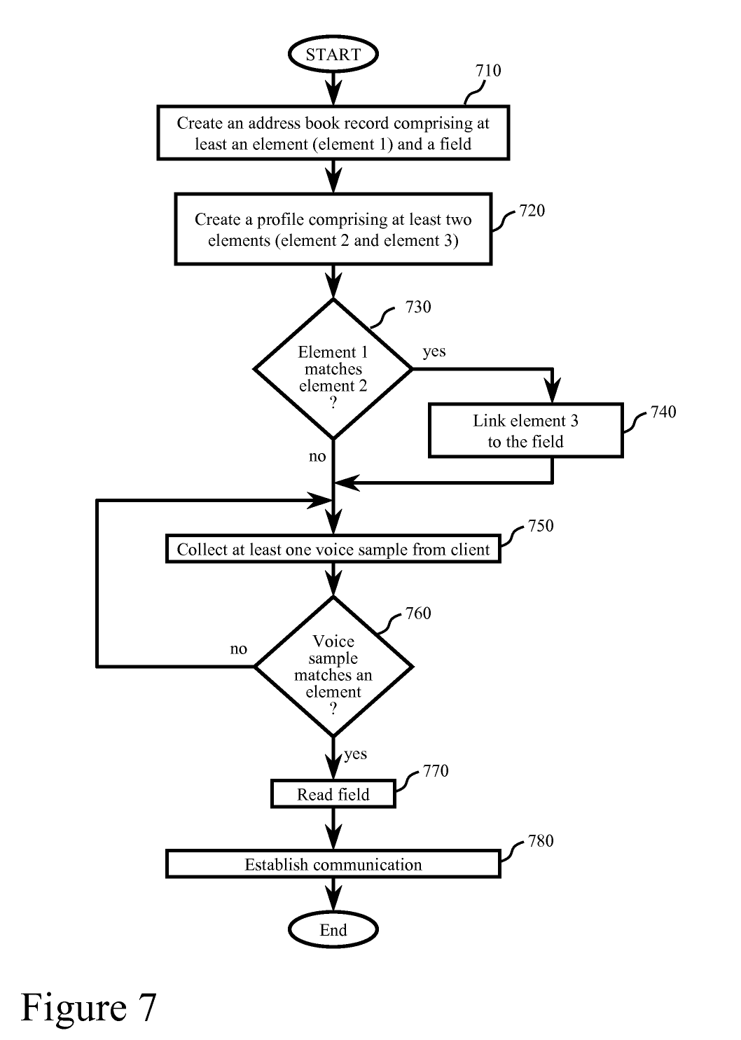

We can summarize a preferred embodiment of the current invention in the system and method of FIG. 7. As described above, details of the invention may vary according to business, marketing, and technical conveniences and needs, but FIG. 7 illustratively demonstrates a useful implementation. In step 710, an address book is created with at least one record, said record comprising at least one element (which we call element 1) and at least one field. This record nominally includes at least some known information pertaining to an associate. In step 720, a profile for said associate is created comprising at least two elements (element 2 and element 3).

For purposes of understanding the principles of the invention, we can refer to FIG. 6 and consider examples of the field and elements as follows: An example of element 1 in FIG. 7 is element 636 in FIG. 6. An example of element 2 in FIG. 7 is element 661 in FIG. 6. An example of element 3 in FIG. 7 is element 666 in FIG. 6. An example of the field in FIG. 7 is field 640 in FIG. 6. Other field and elements combinations, configurations, and contents are possible within the scope of the current invention.

In step 730, a determination is made of whether element 1 matches element 2, and if so, element 3 is linked to the field in step 740. As explained previously, the act of linking may comprise setting up a software pointer, copying element 3 into the field, sharing memory space between the field and element 3, or any other act that makes element 3 available in the address book.

In step 750, at least one voice sample is collected from a client. This voice sample is recognized using a speech recognizer and compared in step 760 to an element (we call an element compared to a speech sample a vocabulary element) in the address book record. The vocabulary element may be element 1, the contents of said field, or another element in the address book record. If the vocabulary element matches the voice sample, then the communication assistant considers the client as having selected the address book record and proceeds to read the field from the record in step 770. Advantageously, if there is no match with any address book record, the client may be reprompted by returning to step 750. Finally, the content of field 770 is used to establish communication in step 780. This act of establishing communication may be any of a number of actions related to said address book information. Many communication options (also called actions) may be envisioned within the scope of the current invention, some of which are listed elsewhere in the application, but we cite, as an example, the action of reading a telephone number from a field and placing a voice call to a destination specified by said field.

As a final example of one embodiment of the current invention, we present a sample conversation between a communication assistant (CA) and a client. This dialog illustrates several of the principles taught by the current invention.

CA: “What would you like to do?”

Client: “Help.”

CA: “You can listen to your email, look up an email address or phone number, make a call, or send email or voicemail. Just say what you want.”

Client: “Check my email.”

CA: “You have one email message from Michael Metcalf. The subject is, ‘Staff meeting.’ The message body reads, ‘David, you'd better be on time for the meeting this time or you're fired.’ Michael Metcalf does not have your new home phone number. Would you like to send it to him?”

Client: “Yes.”

(Since Michael's address book is reachable in this example dialog, Michael's address book is updated. This update can take place via a direct connection between the communication assistant and Michael's address book or by means of an electronic message sent from the communication assistant to a software application that manages or otherwise has access to Michael's address book. If Michael did not have a reachable address book, the communication assistant could have instead sent the information to his inbox via email or to his cell phone via SMS.)

CA: “Your profile information has been added to Michael's address book. What would you like to do?”

Client: “Delete message.”

CA: “Message deleted. What would you like to do?”

(Note that for this next command, the client temporarily takes on the role of an associate who may be called by other clients.)

Client: “Forward my calls to my cell phone.”

CA: “OK. Clients who call you will now be connected to 801-633-5489. What would you like to do?”

Client: “Get an email address for Michael Metcalf.”

CA: “The work email address for Michael Metcalf is michael.metcalf@speechphone.com and the home email address is MDM@ABC.com. You can send this information to your cell phone, send Michael an email message, or start over. What would you like to do?”

Client: “Send him an email message at work.”

CA: “Record your message now.”

Client: “Michael, I hit heavy traffic. I'll be 20 minutes late to the staff meeting.”

CA: Your recorded message has been sent as an email attachment. What would you like to do?”

Client: “Make a call”

CA: “Call whom?”

Client: “Tracy Roberts”

CA: “At what device location, home or work?”

Client: “Home phone.”

CA: “I'll connect you now.”

It is to be understood that this application discloses a system and method for automatically updating an address book for a voice and text communication application. While the invention is particularly illustrated and described with reference to example embodiments, it will be understood by those skilled in the art that various changes in form, details, and applications may be made therein.

What is claimed is:

1. A method of accessing information in an address book, comprising:
creating an address book record comprising a first element and a field;
creating a profile comprising a second element and a third element;
determining whether said first element matches said second element;
linking said third element to said field upon determining that said first element matches said second element;
collecting a first voice sample from a client;
determining whether said voice sample matches an element in said address book record;
and
reading contents of said field.

2. The method of claim 1, wherein said third element is a device identifier.

3. The method of claim 2, further comprising the step of establishing communication between said client and an associate, wherein said associate communicates via a communication device specified by said device identifier.

4. The method of claim 3, wherein said communication device is one or more devices selected from the group consisting of
an analog telephone,
a wireless telephone,
a cell phone,
a digital telephone,
a SIP phone,
a VoIP phone,
a softphone,
a click-to-talk application,
a video phone,
a PDA,
a Wi-Fi phone,
a Wi-Max phone,
a peer-to-peer phone,
a point-to-point phone,
an instant messaging application,
an email system,
and
a voicemail system.

5. The method of claim 1, wherein said profile comprises one or more elements selected from the group consisting of
a pseudonym,
a pronunciation,
a telephone number,
a SIP address,
an IP address,
a telephone extension,
a login name,
an email address,
an account number,
an account identifier,
a department,
an instant messaging handle,
a user handle for one or more peer-to-peer phone services,
a user handle for one or more point-to-point phone services,
a frequency,
a radio operator license call sign,
a license plate number,
a website address,
an employer name,
a home address,
a work address,
age,
height,
marital status,
and
biographical information.

6. The method of claim 1, wherein said first element is provided by a person other than the person providing said second element.

7. The method of claim 1, further comprising the step of sending a message to an associate requesting that said associate update said profile.

8. The method of claim 1, wherein said first element is one or more elements selected from the group consisting of
a name,
a pseudonym,
an email address,
a telephone number,
a telephone extension,
an account number,
an account identifier,
a login name,
an IP address,
a SIP address,
a license plate number,
a website address,
and
an instant messaging handle.

9. The method of claim 1, wherein said second element is an email address.

10. The method of claim 3, wherein said establishing communication comprises one or more actions selected from the group consisting of
placing at least one telephone call,
sending at least one voicemail message,
sending at least one text message
sending at least one SMS message,
sending at least one email message,
sending at least one email message with an attached audio file,
connecting to at least one instant messaging application,
connecting to at least one SIP phone,
connecting to at least one softphone,
connecting to at least one VoIP phone,
connecting to at least one click-to-talk application,
connecting to at least one PDA,
connecting to at least one peer-to-peer phone,
connecting to at least one point-to-point phone,
connecting to at least one Wi-Max phone,
connecting to at least one Wi-Fi phone,
using an electronic switch to establish video communication,
using an electronic switch to establish voice communication,
using an optical switch to establish video communication,
and
using an optical switch to establish voice communication.

11. The method of claim 1, further comprising the step of identifying said client.

12. The method of claim 11, wherein said identifying said client comprises one or more members selected from the group consisting of
collecting a name,
collecting a pseudonym,
collecting a telephone number,
collecting an account number,
collecting an encrypted number,
collecting a password,
collecting a pass phrase,
collecting a PIN,
determining a caller identifier,
detecting caller ID,
detecting ANI,
detecting a SIP address,
detecting an IP address,
detecting a MAC address,
detecting a peer-to-peer handle,
detecting a point-to-point handle,
detecting a device serial number,
detecting a software serial number,
determining the dialed number,
collecting billing information from said client,
collecting biometric information from said client,
and
collecting biographical information from said client.

13. The method of claim 1, wherein said first element is a pseudonym, said third element is a device identifier, and said first element is a vocabulary element.

14. The method of claim 1, wherein said first voice sample contains one or more elements selected from the group consisting of
said associate's name,
part of said associate's name,
a pseudonym,
a telephone number,
a device location,
a telephone extension,
a digit string,
a login name,
an email address,
an account identifier,
a department identifier,
a pseudonym and a department identifier,
a name and a department identifier,
a SIP address,
an IP address,
an instant messaging handle,
a user handle for a peer-to-peer phone service,
a user handle for a point-to-point phone service,
a frequency,
a radio license call sign,
and
a website address.

15. The method of claim 2, wherein said device identifier comprises one of more devices selected from the group consisting of
a telephone number,
a digit string,
a SIP address,
an IP address,
an email address,
a user name,
a handle,
an IM handle,
a frequency,
a URI,
a URL,
a web site address,
a peer-to-peer communication handle,
a point-to-point communication handle,
and
a telephone extension.

16. The method of claim 3, wherein said step of establishing communication comprises one or more actions selected from the group consisting of
ask for help,
forward calls,
look up an email address,
look up a phone number,
update an address book owned by a person other than said client,
place a call,
place a call using call blast,
place a call using a hunt group,
place a videophone call,
place a VoIP call,
send email,
send voicemail,
listen to email,
listen to voicemail,
reply to email,
reply to voicemail,
administer email,
administer voicemail,
send an instant message,
send an SMS message,
send information from an address book record to a communication device,
change privacy settings for profile elements,
and
disconnect from a communication assistant.

17. The method of claim 1, further comprising the step of sending said contents of said field to a destination selected from the group consisting of
an email system;
a telephone;
a cell phone;
a VoIP phone;
a peer-to-peer phone;
a voicemail box;
a pager;
a PDA;
and
an IM application.

18. The method of claim 1, further comprising the step of determining whether said first voice sample contains sufficient information to execute at least one useful action, and, upon determining that said first voice sample does not contain sufficient information to execute at least one useful action, collecting at least one additional voice sample.

19. The method of claim 18, wherein said at least one additional voice sample comprises one or more pieces of information selected from the group consisting of
said associate's name,
part of said associate's name,
a pseudonym,
a telephone number,
a device location,
a telephone extension,
a digit string,
a login name,
a region selected on a display,
an email address,
an account identifier,
a department identifier,
a pseudonym and a department identifier,
a name and a department identifier,
a SIP address,
an IP address,
an instant messaging handle,
a user handle for a peer-to-peer phone service,
a user handle for a point-to-point phone service,
a frequency,
a radio license call sign,
and
a website address.

20. The method of claim 1, further comprising the steps of:
providing said voice sample as input to a speech recognizer;
determining whether
(a) said speech recognizer understands said voice sample with low confidence,
(b) said speech recognizer understands said voice sample with high confidence,
or
(c) said speech recognizer does not understand said voice sample;
prompting said client to confirm upon determining that said speech recognizer understands said voice sample with low confidence;
and
re-prompting said client upon determining that said speech recognizer does not understand said voice sample.

21. The method of claim 1, wherein at least one profile element is designated to have one of a number of security levels.

22. The method of claim 21, wherein said security levels comprise one or more levels selected from the group of readable, private, semi-private, and encrypted.

23. The method of claim 21, wherein a determination is made of whether said designated security level allows said client sufficient access to execute a requested action, and, upon determination that said security level does not allow said client sufficient access to execute a requested action, denying said requested action.

24. The method of claim 21, further comprising the step of determining whether said profile element is designated to have a semi-private level of security, and, upon determination that said profile element is designated to have a semi-private level of security, allowing said client to use said profile element and denying said client the ability to read said profile element.

25. The method of claim 1, wherein at least one group of one or more profile elements is given a group security level such that all profile elements in said group inherit said group security level.

26. The method of claim 1, wherein at least one first profile element is designated to have a first level of security for a first group of one or more clients and at least one second profile element is designated to have a second level of security for a second group of one or more clients, wherein said first level of security is different from said second level of security.

27. The method of claim 1, wherein said updating a profile comprises one or more methods selected from the group consisting of
updating via incoming third-party calls;
updating in association with inbound calls using voice;
updating in association with inbound calls using DTMF;
updating via one or more processor-based, database-connected communication devices on an inbound call;
updating during an email listening session;
updating during an email reading session;
updating via a web site in response to an email request;
updating via a web site;
updating via a web site in response to a suggestion by an email application;
updating via a local software application;
updating based on extraction from existing records;
updating based on extension of an existing service profile;
updating in association with outbound calls using voice;
updating in association with outbound calls using DTMF;
updating via one or more processor-based, database-connected communication devices on an outbound call;
updating by sending an email message;
updating by sending an instant message;
and
updating by sending a text message.

28. The method of claim 1, wherein said first element is an email address, said third element is a telephone number, and said voice sample is a name.

29. The method of claim 1, further comprising the step of collecting a second voice sample.

30. The method of claim 29, further comprising the step of collecting a third voice sample, wherein said third voice sample is a device location.

31. The method of claim 1, wherein said first voice sample contains an action, a name or pseudonym, and a device location.

32. The method of claim 1, further comprising the step of speaking said contents of one or more elements in said address book using one or more methods selected from the group consisting of recorded prompts and text-to-speech synthesis.

33. The method of claim 3, wherein said establishing communication comprises making a first attempt to establish communication via a first communication device, and, if said attempt is unsuccessful, making a second attempt to establish communication via a second communication device.

34. The method of claim 3, wherein said establishing communication comprises:
attempting communication with at least two communication devices simultaneously;
and
establishing communication with the communication device that is answered first.

35. A method of establishing a voice path between an associate and a client, comprising:
said associate updating a profile, wherein at least one fist profile element is an email address, at least one second profile element is a name, and at least one third profile element is a telephone number;
said client creating an address book record comprising an email address of said associate;
determining whether said email address in said address book matches said email address in said profile;
linking said telephone number and said name to said address book record upon determining that said email address in said address book record matches said email address in said profile;
collecting a voice sample from said client, wherein said voice sample matches said name;
in response to said voice sample matching said name, retrieving said telephone number from said address book;
and
dialing said telephone number.

36. The method of claim 36, wherein said first profile element is designated as readable, said second profile element is designated as readable, and said third profile element is designated as semi-private.

37. A method of accessing information in an address book, comprising:
updating an address book comprising information on at least one associate;
sending at least one message to said associate requesting updated information for said associate;
receiving a return message with updated information pertaining to said associate;
automatically updating said address book with said updated information;
collecting a voice sample from a client;
and
retrieving said updated information from said address book.
